(19) United States
(12) Patent Application Publication
(10) Pub. No.: US 2007/0258251 A1
(43) Pub. Date: Nov. 8, 2007

(54) Lamp having double functions

(76) Inventor: Shih-Ming Lin, Shiushui Siang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/416,483

(22) Filed: May 2, 2006

(51) Int. Cl. F21S 8/08

(52) U.S. Cl. 362/410

(57) ABSTRACT

A lamp includes a stand, and a shade mounted on the stand. The stand includes a support post, a base plate mounted on a first end of the support post, and a socket mounted on a second end of the support post. When the shade is rested on the socket of the stand, the lamp functions as a lamp, and when the shade is rested on the base plate of the stand, the lamp functions as a basket. Thus, the lamp both functions as a lamp and a basket, so that the lamp has double functions, thereby enhancing the versatility of the lamp.

### BACKGROUND OF THE INVENTION

1. Field of the Invention

The present invention relates to a lamp and, more particularly, to a lamp having double functions.

2. Description of the Related Art

A conventional lamp comprises a stand, a socket mounted on the stand, an electric bulb mounted on the socket, and a shade mounted on the stand to cover the electric bulb. Thus, the lamp provides an illuminating effect to a user. However, the conventional lamp only has a single function, thereby limiting the versatility of the lamp.

### BRIEF SUMMARY OF THE INVENTION

In accordance with the present invention, there is provided a lamp, comprising a stand, and a shade mounted on the stand. The stand includes a support post, a base plate mounted on a first end of the support post, and a socket mounted on a second end of the support post. The shade is selectively mountable between a first position where the shade is rested on the socket of the stand so that the lamp functions as a lamp, and a second position where the shade is rested on the base plate of the stand so that the lamp functions as a basket.

The primary objective of the present invention is to provide a lamp having double functions.

Another objective of the present invention is to provide a lamp, wherein the lamp both functions as a lamp and a basket, so that the lamp has double functions, thereby enhancing the versatility of the lamp.

A further objective of the present invention is to provide a lamp, wherein the lamp is assembled to form a lamp or a basket easily and rapidly, thereby facilitating a user mounting the lamp.

A further objective of the present invention is to provide a lamp, wherein the lamp is initially assembled to form a basket having multiple storage spaces to store various articles, such as candies, cookies and the like, so as to attract attention of the consumers, especially the children, so that the lamp also functions as a present.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a lamp in accordance with the preferred embodiment of the present invention.

FIG. 2 is a partially cut-away exploded perspective view of the lamp as shown in FIG. 1.

FIG. 3 is a perspective view of the lamp in accordance with another preferred embodiment of the present invention.

FIG. 4 is an exploded perspective view of the lamp as shown in FIG. 3.

FIG. 5 is a perspective view of the lamp in accordance with another preferred embodiment of the present invention.

### DETAILED DESCRIPTION OF THE INVENTION

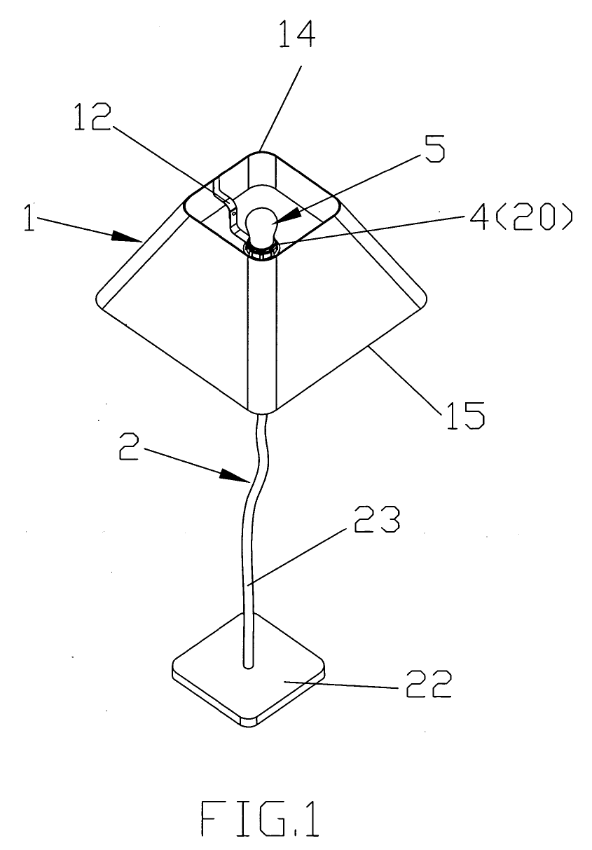

Referring to the drawings and initially to FIGS. 1-4, a lamp in accordance with the preferred embodiment of the present invention comprises a stand 2, and a shade 1 mounted on the stand 2.

The stand 2 includes a support post 23, a base plate 22 mounted on a first end of the support post 23, and a socket 21 mounted on a second end of the support post 23. The socket 21 of the stand 2 has an end portion provided with a threaded portion 20. The end portion of the socket 21 of the stand 2 has a stepped shape. The socket 21 of the stand 2 has a diameter greater than that of the threaded portion 20, and a shoulder 24 is formed between the end portion of the socket 21 and the threaded portion 20.

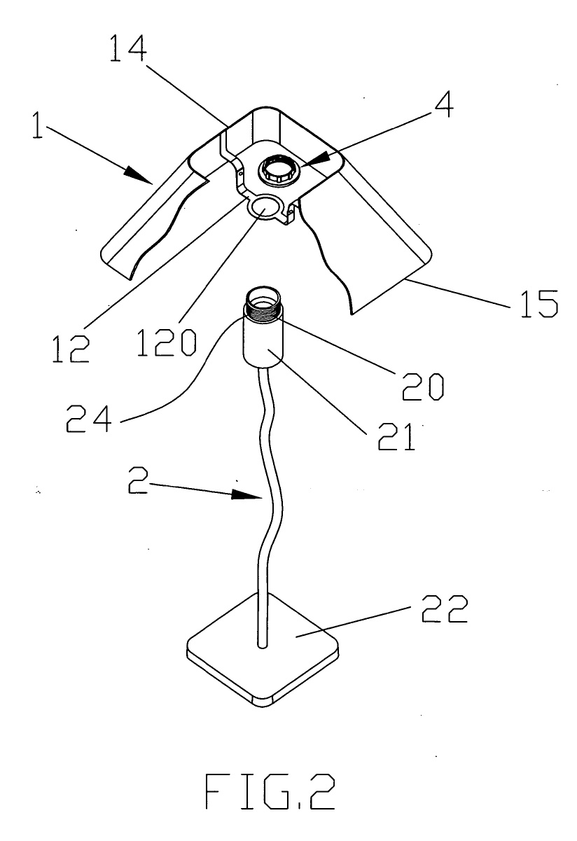

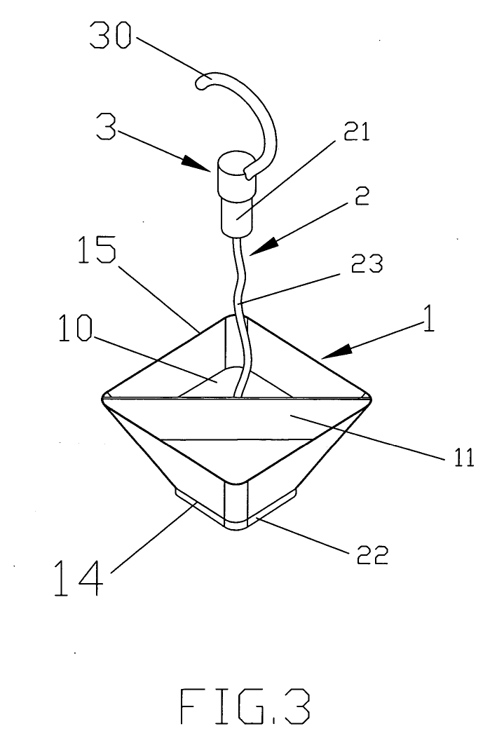

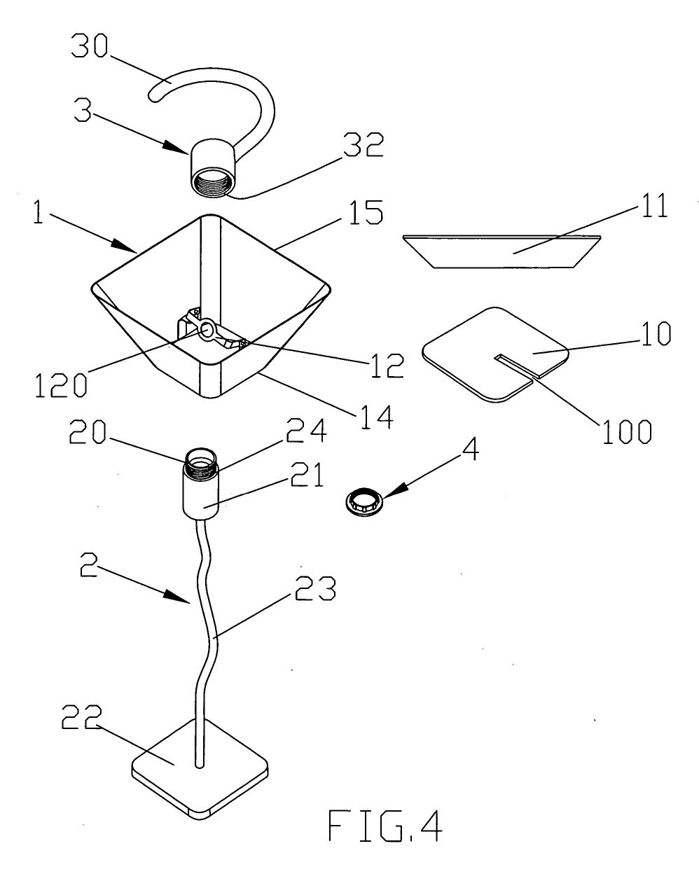

The shade 1 is selectively mountable between a first position where the shade 1 is rested on the socket 21 of the stand 2 as shown in FIGS. 1 and 2 so that the lamp functions as a lamp, and a second position where the shade 1 is rested on the base plate 22 of the stand 2 as shown in FIGS. 3 and 4 so that the lamp functions as a basket. The shade 1 has a hollow inside and has an open first side 14 and an open second side 15 having a size greater than that of the first side 14. The first side 14 of the shade 1 is provided with a support bracket 12 rested on the shoulder 24 of the socket 21 and having a mounting hole 120 mounted on the threaded portion 20 of the socket 21.

As shown in FIGS. 1 and 2, the lamp further comprises a locking nut 4 screwed onto the threaded portion 20 of the socket 21 and rested on the support bracket 12 of the shade 1 to lock the shade 1 onto the socket 21 of the stand 2, and an electric bulb 5 mounted on the locking nut 4 and electrically connected to the socket 21 of the stand 2.

As shown in FIGS. 3 and 4, the socket 21 and the support post 23 of the stand 2 are extended through the shade 1 from the first side 14 toward the second side 15 of the shade 1, and the base plate 22 of the stand 2 is rested on the first side 14 of the shade 1.

The lamp further comprises a support plate 10 mounted in the shade 1 and located adjacent to the first side 14 of the shade 1, a separation plate 11 mounted in the shade 1 and rested on the support plate 10 to separate the inside of the shade 1 into two storage spaces, and a hanging member 3 mounted on the socket 21 of the stand 2 for hanging the stand 2. Thus, the support bracket 12 of the shade 1, the locking nut 4 and the electric bulb 5 are hidden between the support plate 10 and the base plate 22 of the stand 2. The support plate 10 is formed with an elongated slit 100 to allow passage of the support post 23 of the stand 2. The hanging member 3 is rested on the shoulder 24 of the socket 21 and has an inner wall formed with a screw bore 32 screwed onto the threaded portion 20 of the socket 21 and an outer wall provided with a hook 30 for hanging the hanging member 3.

In assembly, referring to FIGS. 1 and 2, when the shade 1 is rested on the socket 21 of the stand 2, the support bracket 12 of the shade 1 is rested on the shoulder 24 of the socket 21. Then, the locking nut 4 is screwed onto the threaded portion 20 of the socket 21 and rested on the support bracket 12 of the shade 1 to lock the shade 1 onto the socket 21 of the stand 2. Finally, the electric bulb 5 is mounted on the locking nut 4 and electrically connected to the socket 21 of the stand 2. Thus, the lamp functions as a lamp.

Alternatively, referring to FIGS. 3 and 4, the socket 21 and the support post 23 of the stand 2 are extended through the shade 1 from the first side 14 toward the second side 15 of the shade 1, and the base plate 22 of the stand 2 is rested on the first side 14 of the shade 1. Then, the support plate 10 is mounted in the shade 1 so that the support bracket 12 of the shade 1, the locking nut 4 and the electric bulb 5 are hidden between the support plate 10 and the base plate 22 of the stand 2. At this time, the elongated slit 100 of the support plate 10 allows passage of the support post 23 of the stand 2. Then, the separation plate 11 is mounted in the shade 1 and rested on the support plate 10 to separate the inside of the shade 1 into two storage spaces. Finally, the hanging member 3 is screwed onto the threaded portion 20 of the socket 21. Thus, the lamp functions as a basket.

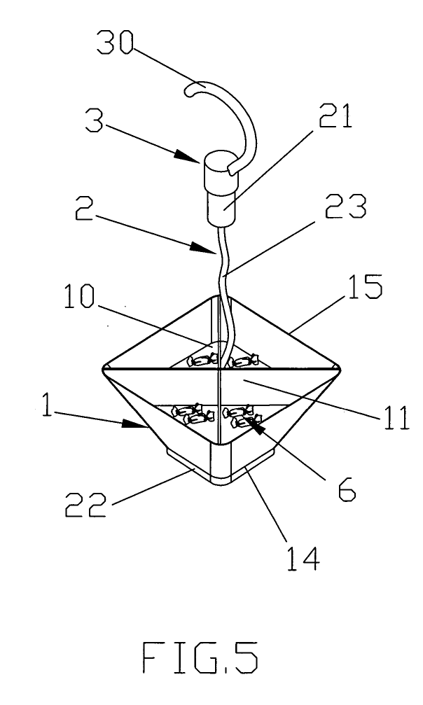

Referring to FIG. 5, the lamp comprises two intersecting separation plates 11 mounted in the shade 1 and rested on the support plate 10 to separate the inside of the shade 1 into four storage spaces to store various articles 6, such as candies, cookies and the like.

Accordingly, the lamp both functions as a lamp and a basket, so that the lamp has double functions, thereby enhancing the versatility of the lamp. In addition, the lamp is assembled to form a lamp or a basket easily and rapidly, thereby facilitating a user mounting the lamp. Further, the lamp is initially assembled to form a basket having multiple storage spaces to store various articles 6, such as candies, cookies and the like, so as to attract attention of the consumers, especially the children, so that the lamp also functions as a present.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A lamp, comprising a stand, and a shade mounted on the stand, wherein:
the stand includes a support post, a base plate mounted on a first end of the support post, and a socket mounted on a second end of the support post;
the shade is selectively mountable between a first position where the shade is rested on the socket of the stand so that the lamp functions as a lamp, and a second position where the shade is rested on the base plate of the stand so that the lamp functions as a basket.

2. The lamp in accordance with claim 1, wherein the shade has an open first side and an open second side.

3. The lamp in accordance with claim 2, wherein the second side of the shade has a size greater than that of the first side.

4. The lamp in accordance with claim 2, wherein the socket of the stand has an end portion provided with a threaded portion.

5. The lamp in accordance with claim 4, wherein the first side of the shade is provided with a support bracket rested on the socket and having a mounting hole mounted on the threaded portion of the socket.

6. The lamp in accordance with claim 4, wherein the end portion of the socket of the stand has a stepped shape.

7. The lamp in accordance with claim 4, wherein the socket of the stand has a diameter greater than that of the threaded portion, and a shoulder is formed between the end portion of the socket and the threaded portion.

8. The lamp in accordance with claim 7, wherein the support bracket of the shade is rested on the shoulder of the socket.

9. The lamp in accordance with claim 1, wherein the shade has a hollow inside.

10. The lamp in accordance with claim 5, further comprising a locking nut screwed onto the threaded portion of the socket and rested on the support bracket of the shade to lock the shade onto the socket of the stand.

11. The lamp in accordance with claim 10, further comprising an electric bulb mounted on the locking nut and electrically connected to the socket of the stand.

12. The lamp in accordance with claim 2, wherein the socket and the support post of the stand are extended through the shade from the first side toward the second side of the shade, and the base plate of the stand is rested on the first side of the shade.

13. The lamp in accordance with claim 2, further comprising a support plate mounted in the shade and located adjacent to the first side of the shade.

14. The lamp in accordance with claim 13, wherein the support plate is formed with an elongated slit to allow passage of the support post of the stand.

15. The lamp in accordance with claim 13, further comprising a separation plate mounted in the shade and rested on the support plate to separate an inside of the shade into two storage spaces.

16. The lamp in accordance with claim 4, further comprising a hanging member mounted on the socket of the stand for hanging the stand.

17. The lamp in accordance with claim 16, wherein the hanging member has an inner wall formed with a screw bore screwed onto the threaded portion of the socket.

18. The lamp in accordance with claim 16, wherein the hanging member has an outer wall provided with a hook for hanging the hanging member.

19. The lamp in accordance with claim 13, further comprising two intersecting separation plates mounted in the shade and rested on the support plate to separate an inside of the shade into four storage spaces.
